(19) United States
(12) Patent Application Publication
(10) Pub. No.: US 2006/0272716 A1
(43) Pub. Date: Dec. 7, 2006

(54) METHOD OF ADHESIVELESS LAMINATION OF POLYMER FILMS INTO MICROFLUIDIC NETWORKS WITH HIGH DIMENSIONAL FIDELITY

(75) Inventors: Kenneth Hawkins, Sammamish, WA (US); David Markel, Boise, ID (US); Paul Yager, Seattle, WA (US); Matthew S. Munson, Gaithersburg, MD (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: University of Washington, Seattle, WA (US)

(21) Appl. No.: 11/382,779

(22) Filed: May 11, 2006

Related U.S. Application Data
(60) Provisional application No. 60/680,789, filed on May 12, 2005.

(51) Int. Cl. F15C 1/06

(52) U.S. Cl. 137/833

(57) ABSTRACT

A method for fabricating an adhesiveless microfluidic device using solvent assisted thermal welding is provided. The method comprises use of a plurality of device layers of a bulk chemical conformation composition having a glass transition temperature that can be disrupted by a disrupting agent without total solvation, wherein the plurality of device layers when assembled define a plurality of defined component features. The device layers are immersed into the disrupting agent for a time period sufficient to disrupt the glass transition temperature of a defined depth of the surfaces of the device layers prior to their removal from the disrupting agent. The plurality of device layers are assembled and registered by contacting the plurality of device layer surfaces to form the defined component features. Pressure and heat are simultaneously applied to bring the assembly to a temperature below the pressure-specific, glass transition temperature of the bulk chemical conformation composition; but above the pressure-specific, glass transition temperature of the disrupted surface layer of the composition, for a time period sufficient to affect a weld between the contacted surfaces of the plurality of device layers. The temperature of the assembly is reduced over a time period sufficient to anneal the contacted surfaces of the plurality of device layers to form the microfluidic device.

### CROSS REFERENCES TO RELATED APPLICATIONS

The present application claims priority to U.S. Provisional Patent Application No. 60/680,789, filed May 12, 2005, the entire disclosure of which is incorporated by reference herein.

### STATEMENT AS TO RIGHTS TO INVENTIONS MADE UNDER FEDERALLY SPONSORED RESEARCH AND DEVELOPMENT

Aspects of the present invention were conducted with funding provided by the National Institutes of Health under Grant Nos. 8 R01EB002023-03 and 1 U01DE1497-01. The Government may have certain to rights in the claimed invention.

### BACKGROUND OF THE INVENTION

Polymers and plastics are receiving increased attention as materials for microfluidic applications. Several recent reviews are devoted to this topic (Becker et al., Talanta, 56:267-287 (2002); Boone et al., Anal. Chem. 74:78A-86A (2002); de Mello, Lab on a Chip, 2:31N-36N (2002)). Plastics have numerous desirable characteristics as substrates for microfluidic devices; e.g., the raw materials are relatively inexpensive and accessible, several fabrication techniques can yield nearly straight channel walls, and there are methods developed for rapid prototyping. The choice of polymer film is driven by the physical and optical properties, and other design specifications (Hawkins et al., Lab on a Chip, 3:248-252 (2003)).

There are many fabrication techniques that can be used to construct plastic and polymer, lab-on-a-chip devices. CO₂-laser photoablation was recently well described for etching channels into thick polymer slabs. (Jensen et al., Lab on a Chip, 3:302-307 (2003); Klank et al., Lab on a Chip, 2:242-246 (2002); Bowden et al., Lab on a Chip, 3:221-223 (2003)). Direct-write, CO₂-laser, through-cutting of polymer films and adhesive-lamination has been demonstrated as a good method for achieving finished three-dimensional microfluidic channels within a few hours of completing the design drawings. (Hatch et al., Nature Biotech., 19:461-465 (2001); Munson et al., Lab on a Chip, 4:438-445 (2004)).

Lamination of through-cut films has several advantages over the etching of slabs. The resulting channels are rectangular in cross section, as opposed to the Gaussian cross-section that usually results from slab etching (or the rough surface that results from an attempt to create a rectangular channel by the superposition of Gaussian cuts). (Jensen et al., Lab on a Chip, 3:302-307 (2003)). Complex three-dimensional fluidic networks can be built up in a relatively thin device. (Munson et al., Lab on a Chip, 4:438-445 (2004)). This method also enables rapid prototyping—a great benefit for iterative design cycles.

Adhesive lamination of through-cut films has certain inherent problems. The use of adhesives in microfluidic reactors (such as the T-sensor) can create problems due to adsorption of reactants to the adhesive, absorption of reactants into the adhesive, leaching of complex adhesive components into the reaction mixture, interference with fluorescence detection from adhesive auto-fluorescence, and mechanical delamination from failure of the adhesive. All of these problems have been observed. (Hawkins et al., Lab on a Chip, 3:248-252 (2003); Hatch et al., Nature Biotech., 19:461-465 (2001); Hatch, Bioengineering, Seattle, University of Washington (2004)). It is also difficult to apply a uniform, thin layer of adhesive without commercial equipment—many artisans use films with pre-applied adhesive layers, which are much more expensive than the base polymer films. Lamination “foils” exist that can form a heterogeneous bond (analogous to a solder joint), but this method still introduces a second material. The ideal bonding method would result in a monolithic device that presented a single surface type to the fluids in the network.

Solvent assisted thermal welding (SATW) has been described in detail for macro-scale processing. Good reviews of polymer joining techniques are available in the art. See for example, Stokes, Polymer Engineering and Science, 29:1310-1324 (1989) and Wool et al., Polymer Engineering and Science, 29:1340-1367 (1989). Recently, SATW has been used to create facile bonds to attach cover layers for slab etched microfluidic devices comprising several different polymer substrates. (Klank et al., Lab on a Chip, 2:242-246 (2002); Bowden et al., Lab on a Chip, 3:221-223 (2003); Liu et al., Anal. Chem., 76:1824-1831 (2004)). SATW is similar in many respects to other types of polymer welding; e.g., solvent welding or heat welding. However, SATW as defined in the present invention provides a process that has several advantages for lamination of microfluidic devices including for example: (1) treatment of the entire surface of the parts means that all surfaces are involved in the weld, even if they are located internally and therefore inaccessible to local application of heat; (2) tight control over the thickness of the disrupted layer that is actually involved in the weld results in better control over the dimensional fidelity of the process; (3) bonding is not immediate (with the appropriate choice of materials), so alignment of features can be done during final assembly, and the like.

### BRIEF SUMMARY OF THE INVENTION

The present invention provides methods for fabricating microfluidic devices without the use of adhesives. Microfluidic devices fabricated by the methods are also provided. In one aspect of the invention, a method for fabricating a microfluidic device comprises providing a plurality of device layers comprising a bulk chemical conformation composition having a glass transition temperature that can be disrupted by a disrupting agent without total solvation. The plurality of device layers when assembled define a plurality of defined component features. The plurality of device layers are immersed into the disrupting agent for a time period sufficient to disrupt the glass transition temperature of a defined depth of the surfaces of the device layers. The immersed device layers are then assembled and registered by contacting the plurality of device layer surfaces to form the defined component features of the device. Simultaneous pressure and heat is applied to bring the plurality of device layers to a temperature below the pressure-specific, glass transition temperature of the bulk chemical conformation composition, but above the pressure-specific, glass transition temperature of the disrupted surface layer of the composition, for a time period sufficient to affect a weld between the contacted surfaces of the plurality of device layers. The temperature is incrementally reduced over a time period sufficient to anneal the plurality of device layers.

In a particular embodiment of the invention the pressure can be applied to the plurality of device layers with a first substantially flat platen and a second substantially flat platen. Heat can be applied by inserting the assembled and registered device layers into an oven or through the platens. Assembly and registration of the plurality of device layer can be carried out with an assembly jig that maintains the proper registration of the plurality of device layers to form the defined component features. The jig can also comprise two flat plates or platens. The platens can be substantially flat and smooth. To obtain the smooth platen surface, the platen can be polished or the platen surface can be covered with a material layer that is substantially smooth. In one embodiment of the invention the material layer is Mylar. In particular embodiments of the method of the invention the excess disrupting fluid can be removed from the plurality of device layers.

The microfluidic devices fabricated by the methods of the present invention can comprise a first and second cover layer and a plurality of device layers cut through such that when assembled the plurality of device layers form the defined component features. Bulk chemical conformation compositions useful in the methods of the present invention can comprise a polymer film. The polymer film can be polymethyl methacrylate (PMMA), a cyclic polyolefin, a polycarbonate, or a polystyrene. The cognate disrupting agent can be a solvent. Typically the solvent of the present invention penetrates into the bulk chemical conformation composition and disrupts the chemical conformation of the polymer sufficiently to lower the glass transition temperature of the composition to form a surface reactive layer without completely dissolving or softening the entire bulk of the composition. In particular embodiments of the present invention the disrupting fluid comprises ethanol, benzaldehyde, an aldehyde, or an acetone of an aldehyde. Typical polymer and cognate disrupting fluid pairs include, for example, polymethyl methacrylate and ethanol; a cyclic polyolefin and benzaldehyde; a polycarbonate and acetone; or polystyrene and an aldehyde.

In a particular embodiment of the present invention the method for fabricating a microfluidic device comprises the steps of: providing a first substantially flat platen and a second substantially flat platen; providing a plurality of device layers comprising polymethyl methacrylate, wherein the plurality of device layers when assembled define a plurality of defined component features; providing an assembly jig that maintains the proper registration of the plurality of device layers to form the defined component features; immersing the plurality of device layers into ethanol for a time period sufficient to disrupt the glass transition temperature of a defined depth of the surfaces of the device layers; removing the plurality of device layers from the ethanol; removing excess ethanol from the plurality of device layers; assembling the plurality of device layers onto the assembly jig by contacting the plurality of device layer surfaces to form the defined component features; applying simultaneous pressure and heat to the first and second platen, wherein heat is applied to bring the assembly to a temperature below the pressure-specific, glass transition temperature of the polymethyl methacrylate; but above the pressure-specific, glass transition temperature of the disrupted surface layer of the polymethyl methacrylate, for a time period sufficient to affect a weld between the contacted surfaces of the plurality of device layers; and reducing incrementally the temperature of the first and second platen, and the assembly jig over a time period sufficient to anneal the contacted surfaces of the plurality of device layers to form the microfluidic device. Typically with this method the device layers can be 0.175 mm thick, the time period of exposure to disrupting fluid is ten minutes, and the assembly is heated to 95° C. for 90 minutes. When PMMA is used as the polymer film the ethanol disrupting fluid is typically absolute ethanol.

A microfluidic device fabricated by the methods of the present invention comprise any device that is known in the art. The device typically comprises a plurality of component features. In one particular embodiment of the present invention, the device comprises a first and second cover layer and a device layer having a plurality of component features cut through the device layer. In a more complex embodiment of a device, the device comprises a plurality of core layers fabricated by the methods of the present invention and a plurality of outer layers fabricated using an adhesive. The outer layers comprise a first and second cover layer and do not necessarily comprise the same polymer film composition. In one embodiment of the invention the first and second cover layer comprise Mylar.

### BRIEF DESCRIPTION OF THE DRAWINGS

FIG. 1 describes a scale drawing of the T-sensor microfluidic channel used as the basic test device. The main channel is 1.5 mm×40 mm, cut through the center layer of a three-layer device. The top layer has inlet holes that mate with the two channel inlets and the single outlet. The bottom layer caps the channel. The thickness of the film (0.1 mm) is drawn here to scale also, but is barely noticeable.

FIGS. 2A-2D describe a multilayer microfluidic device to create 3-D sheathing of flow to eliminate surface adsorption of reactants. This device is shown as an example of the level of sophistication of which this fabrication technique is capable. FIG. 2A provides an optical micrograph of the inlet area of the actual device in bright field. FIG. 2B provides a fluorescence image of the inlet area of the actual device with green fluorescent dye injected into the sheath. FIG. 2C provides a fluorescence image of the inlet area of the actual device with red fluorescent dye injected into the core. FIG. 2D provides a three dimensional rendering of the device design.

FIGS. 3A-3C provide some of the results of preliminary experiments into SATW parameters using the T -sensor design in FIG. 1 (with additional holes for registry and mounting of the device into a fluidic manifold). FIG. 3A provides a useable device that seals against normal pressure, has no obvious defects, and performs as predicted. FIG. 3B depicts a device that does not seal due to inadequate pressure during the bonding cycle. The poorly-bonded region can be seen in the center of the device as a milky stripe. FIG. 3C depicts a device which has been crushed; notice that the inlet channels have almost disappeared, the main channel does not reach the outlet hole, there are numerous bubbles, and the device became so brittle that the corner was broken off during handling. This device was made before the production parameters were well understood. Devices B and C were negatively impacted by the lack of flatness of the jig. In device A the sealing quality was improved using the technique described below.

FIGS. 4A and 4B provide optical micrographs (4X) of T-sensor channels showing the effect of jig roughness. FIG. 4A depicts a portion of the main channel in a device showing the tooling marks on the outer surface of the device that were transferred from the jig. Note also that this device demonstrates the channel occlusion characteristic of the endpoint represented in FIG. 3C. FIG. 4B depicts the junction of the inlets in a device that was made with the polished jig. Note the absence of obvious tooling marks. (Some dust and fibers of unknown origin are visible on the device surface. Bubbles indicate possible incomplete bonding; although, this device was fully functional).

### DETAILED DESCRIPTION OF THE INVENTION

The present invention provides a method for laminating machined polymer films into three dimensional microfluidic networks that do not require an adhesive. The basic method—solvent assisted thermal welding (SATW)—is not new, and has previously been applied to attaching cover layers to slab based microfluidic networks. The present method provides for the use of SATW for laminating films (defined herein as a bulk polymer or copolymer material comprising <0.5 mm in thickness) to eliminate the need for adhesives in polymeric microfluidic applications. Typically, the use of adhesives in microfluidic devices (such as the T-sensor, see for example U.S. Pat. Nos. 5,716,852; 5,972,710, and 6,541,213) can create problems due to adsorption of soluble species in a microfluidic fluid to the adhesive, absorption of the soluble species into the adhesive, leaching of complex adhesive components into the microfluidic fluids, interference with fluorescence detection from adhesive auto-fluorescence, mechanical delamination of the microfluidic device from failure of the adhesive, and the like. Lamination of multiple device layers with SATW by the methods of the present invention alleviates these problems because the bond between each layer of the lamina is a true weld; i.e., it is formed from the same material as the bulk and is chemically and mechanically indistinguishable from the bulk. Contrasted with other common polymer welding techniques (e.g., solvent alone, heat alone, and the like), SATW is better at producing a true weld without any significant sacrifice of the dimensional fidelity of the component parts to accomplish the weld. This is of paramount importance in the fabrication of microfluidic networks, given the inherently tight absolute dimensional tolerances that result from the small size scale.

Therefore, the present invention provides methods for solvent assisted temperature welding (SATW) of polymer-films comprising a bulk polymer that enables the adhesive-free assembly of three-dimensional microfluidic networks into credit-card sized lab-on-a-chip devices. As used herein the term “adhesiveless” or “adhesive free” refers to the lack of a substance adapted to stick, bond, or otherwise adhere the surfaces of one or more polymer layers to one another. The device can comprise a plurality of device layers of through-cut parts of a suitable bulk polymer-film which can be assembled into three-dimensional networks with a relatively short, simple procedure. The device is also comprised of one or more cover layers which substantially seal the device. By “substantially seal” is meant that the device has a sufficiently low unintended leakage rate and/or leakage volume under given flow, fluid identity, or pressure conditions. Types of unintended leakage include leakage or pooling that accumulates in unintended regions between device layers and leakage to an environment outside a microfluidic device. A substantially sealed assembly is contemplated to have one or more fluidic ports or apertures to provide desirable fluidic inlet or outlet utility.

The term “microfluidic” as used herein is to be understood to refer to structures or devices through which one or more fluids are capable of being passed or directed, wherein one or more of the dimensions of any fluidic passage (or channel) defined therein is less than about 1 mm.

The plurality of device layers when assembled define a one or more defined component features of the microfluidic device of the present invention. A component feature of the microfluidic device can comprise one or more of the following features including a channel and/or chamber, a fluidic port, a valve, a mixing area, and the like. The various component features common to a microfluidic device are well known to the skilled artisan and can be included in a device fabricated by a method of the present invention. The component features of a particular device will be dependent on the intended use of the device itself.

In a method of the present invention, the plurality of device layers are first fully immersed in a “disrupting fluid” for a pre-defined time. The disrupting fluid of the present invention defines a fluid that penetrates into the bulk chemical conformation composition, for example a bulk polymer, a short distance (the surface reactive layer), and disrupts the chemical conformation of the bulk chemical composition or bulk polymer sufficiently to lower the glass transition temperature (T_{g}) of the bulk polymer in the surface reactive-layer, without completely dissolving or softening the entire bulk of the composition. The thickness of the surface reactive layer is controlled by the composition of, and duration of exposure to, the disrupting fluid. After the pre-defined immersion time, the plurality of device layers are removed from the disrupting fluid. In certain embodiments of the present invention the disrupting fluid can be removed prior to the next step. Typically, the disrupting fluid is selected based on the bulk chemical conformation composition selected. For example, ethanol is used if the composition selected typically is polymethyl methacrylate (PMMA), benzaldehyde is typically used with cyclic polyolefins, acetone is typically used with polycarbonate, aldehydes are typically used with polystyrenes, and the like. Generally, the disrupting fluid in the pair is typically a fluid to which the bulk chemical conformation composition has “limited resistance” or “partial resistance.”

Bulk chemical conformation compositions useful in the present invention typically comprise substantially colorless polymer or copolymer layers. But, typically the selection of the bulk polymer is based on the individual design specifications of the microfluidic device. This can include, for example, the pressure under which the device will be used, the detection system, and the like. The main requirement is that the bulk polymer have a cognate disrupting fluid that is capable of depressing the T_{g} enough to enable the surface layer to be brought to above that temperature without the bulk temperature exceeding the bulk polymer T_{g}. This is a function of the thermal conductivity and heat capacity of the polymer and the thickness of the polymer film, as well as the chemical interaction of the disrupting fluid and the bulk polymer. The polymers are typically un-oriented to minimize unpredictable shrinkage and distortion. Further, the polymer is typically a thermoplastic. Representative polymers useful in the methods of the present invention include for example, acrylates (typically including, methacrylates, such as polymethyl methacrylate (PMMA)), cyclic polyolefins, polycarbonates, polystyrenes, and the like. In a particular embodiment of the present invention polymethyl methacrylate (PMMA) is used with ethanol as the disrupting fluid.

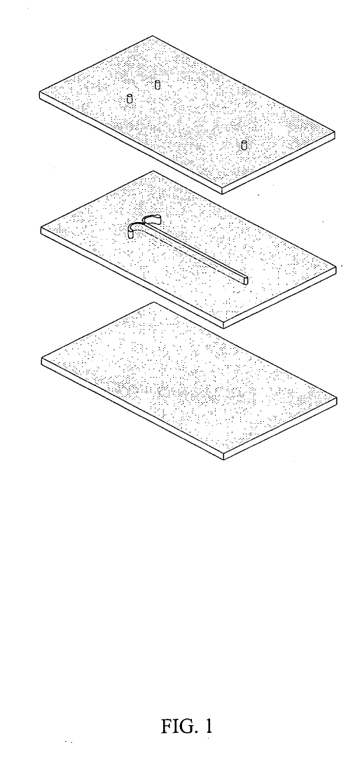

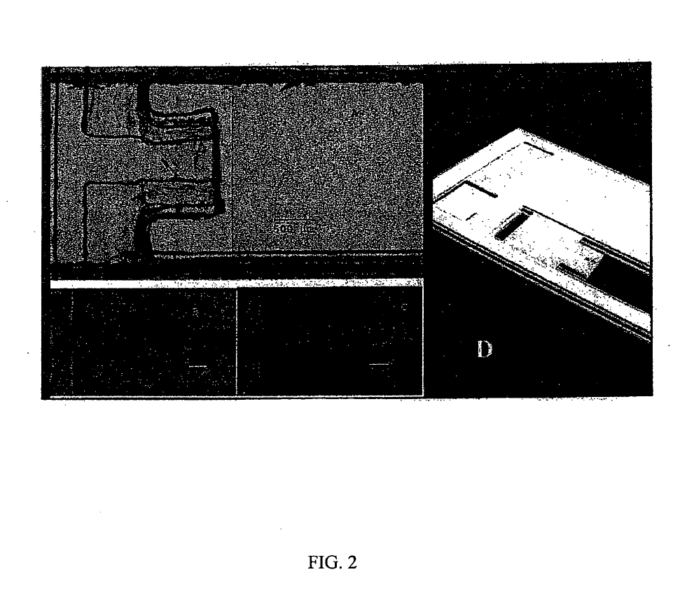

Microfluidic devices of the present invention can be simple multilayer devices or they can be more complex. In one embodiment of the present invention a simple microfluidic device comprises three layers. (FIG. 1). In other embodiments a more complex microfluidic device can be fabricated. In one embodiment of the present invention, the inner core of the device can be welded using SATW while additional layers can be attached to the core using another method. One such method comprises the use of an adhesive, but can include thermal welding or a solvent based welding. In a particular device of the present invention, there are seven layers. (FIGS. 2A through 2D). Only the three core layers of the device comprising PMMA are welded together using solvent assisted thermal welding. The remaining layers are bonded to the core using adhesive. This particular embodiment of the invention is designed to use a sheath of solvent between the microfluidic device channel and the reaction solution to reduce contact between outer layers of the device and the reaction mixture in certain regions of the device. It should be noted that the entire microfluidic device can be constructed entirely with layers of PMMA using the methods of the present invention.

In the method of the present invention for fabrication of a microfluidic device, the plurality of device layers comprising the bulk chemical conformation composition are immersed in the disrupting agent for a period of time sufficient to penetrate into the polymer a short distance. The bulk chemical conformation composition and disrupting agent are selected such that the composition has a glass transition temperature that can be disrupted by the disrupting agent. Immersion is for a time period sufficient to disrupt the glass transition temperature of the composition to a defined depth. The plurality of device layers are removed from the disrupting agent and the device layers are stacked or assembled and registered in the proper order to provide a device having the desired component features. In certain embodiments of the present invention the excess disrupting agent is removed prior to assembly of the device layers.

Assembly and registration of the plurality of device layers may be carried out on a jig and the layers are clamped in the jig which has been designed to maintain the registration of key features (e.g., an outlet hole with a channel terminus). The jig is then subjected to controlled pressure normal to the lamination plane, and controlled heat to bring the parts to a temperature below the glass transition temperature (T_{g}) of the polymer bulk, but above the T_{g} of the reactive layer. These conditions are maintained for a time sufficient to affect a weld between the reactive layers of the various parts. The jig can further comprise substantially flat first and second platens. Heat can be provided, for example, by inserting the jig with the assembled device layers into an oven or the jig can further comprise platens having a heating device. During the heating step, the platens typically maintain contact with the outer layers surrounding the assembled device layers.

The temperature of the now-welded parts is then ramped down with a specified cycle to affect annealing of any residual stresses. The resulting weld will have mechanical and chemical properties essential identical to the bulk film, thus avoiding the undesirable effects of a laminating adhesive or foil.

In a particular embodiment of the present invention, a plurality of device layers after having been immersed in the disrupting fluid and having excess disrupting fluid removed are placed between substantially flat first and second platens having a registration device. In certain embodiments, one or more discrete microfluidic device layer stacks or an array of devices comprising a discrete number of microfluidic devices having a defined set of component features can be placed between the platens. The device layers can be scored or perforated to aid in the separation of each individual device from the array to from multiple discrete devices following the assembly of the device layers.

This technique should be applicable to any polymer film and disrupting fluid combination. Examples of this include, but are not limited to, films and fluids listed in Table 1.

TABLE 1
Some possible film and disrupting fluid pairs*

| Polymer Films | Disrupting Fluid |
|---|---|
| Polymethyl methacrylate (PMMA) | Ethanol |
| Cyclic Polyolefins | Benzaldehyde |
| Polycarbonate | Acetone |
| Polystyrene | Aldehydes |
| Note: | |
| The polycarbonate/acetone pair has been described by others for joining thicker substrates. (Liu et al., Anal. Chem., 76: 1824-1831 (2004)). Identification of other possible pairs is based on the advertised | |
| # chemical resistance of these polymers. The disrupting fluid in the pair is a fluid to which the polymer has “limited resistance”, or “partial resistance”. | |

Platens when used as the surface of the jig in the methods of the present invention can comprise a substantially flat surface. In particular embodiments of the present invention the platen surfaces of the jig can be polished to also present a substantially smooth surface to contact the device layers. Instead of polishing, the platen surfaces of the jig can be covered with a smooth material layer, such as for example, Mylar, to provide a smooth surface between the platen and the device layers. In certain embodiments the platens can also comprise a device for providing heat with a closed loop control. The heated platens should also have sufficient thermal conductivity and thermal mass to insure that the polymer layers are maintained within the desired temperature range (between the T_{g} of the disrupted layer and the T_{g} of the bulk polymer).

The present invention will be better understood by reference to the following examples. The examples are offered by way of illustration, not by way of limitation.

### EXAMPLE

The following example demonstrates the present invention using a model system with Rohaglas (optically clear polymethyl methacrylate or PMMA) as the polymer film and ethanol as the disrupting fluid.

Materials: 0.175-mm thick PMMA (Rohaglas formulation #99524, Cyro Industries, Orange, N.J., USA) was used for all parts discussed. Absolute 2000 USP-grade ethanol, (AAPER Alcohol and Chemical Company, She1byville, Ky., USA) was used as the disrupting fluid. A custom-machined aluminum assembly jig transferred heat and pressure, and maintained the proper registration of the component part through dedicated holes in each part that fit precisely over pins in the jig. The initial proof-of-principle was demonstrated using an inexpensive machinist's vise (Wilton model 30, WMH Tool Group, Elgin, Ill., USA) to apply the pressure, and a bench-top laboratory oven to control the temperature (Shel Lab model #1330 GM, Sheldon Manufacturing, Cornelius, Oreg., USA). A temperature-controlled platen press (Tetrahedron model MTP-14, Tetrahedron Associates, Inc., San Diego, Calif., USA) was used later to precisely control the force and temperature applied.

Device Design: Several device designs have been successfully fabricated using the system described above. The simplest—a T-sensor with a main channel having the dimensions length=40-mm, depth=1.6-mm, and width=0.175-mm—was used for preliminary feasibility (FIG. 1). A more complicated three-layer device designed to produce three-dimensional sheathed flow was also fabricated (FIGS. 2A through 2D). The complex device consisted of 7 layers, numbered in ascending order from the bottom layer. Layers 3, 4, and 5 were cut from 175 μl thick sheets of PMMA (G.E. Polymer Shapes, Trenton, N.J.) rather than Mylar. Layers 2 and 6 were cut from sheets of 150 μm thick sheets of adhesive coated Mylar (ACA) and layers 1 and 7 were cut from sheets of 250 μm thick Mylar. Core layers (layers 3, 4 and 5) of the sheath flow device were fabricated using SATW, but the outer layers were attached using adhesive; thus eliminating adhesive (and the resulting undesirable absorption) in certain areas primarily in contact with the reaction mixture and, at the same time, demonstrating the compatibility of SATW with other fabrication processes. Further optimization of the process is continuing using the T-sensor as the model device.

Procedure:

Devices were laser machined to specified dimensions and then laminated with the SATW process described above. Numerous replicates of the devices were fabricated to assess the repeatability of the process.

T-sensor and sheath-flow devices were fabricated first with the vise-and-oven process to assess the feasibility of the process. The primary functional test applied to these devices was suitability of end use—did it seal and permit the desired flow? The best devices were made by soaking of the PMMA in ethanol for 10 minutes, shaking and blotting to remove all excess ethanol, tightening the vise to something more than “finger tight”, and then incubating for 90 minutes at 95° C. The oven was then shut off, and the parts were allowed to cool to room temperature while still under pressure in the jig. This process has several steps where operator discretion significantly impacts the results—most notably the amount of pressure applied.

A more detail description of the assembly of the sheath-flow device is as follows: Layers 3, 4 and 5 were immersed in ethanol (Aaper, Shelbyville, Ky.) for 10 min. The layers were removed from the ethanol and gently patted dry. The layers were aligned using an assembly jig, and then clamped between two metal plates. The plates were clamped with a bench-top vice and a C-clamp. The entire assembly was placed in an oven at 95° C. After 90 min, the oven was turned off. The oven and the assembly were allowed to return to room temperature over a period ranging from 3 to 24 hours. This step acted as an annealing step and was necessary to prevent stress fractures from forming. The adhesive free core layers were then laminated with the ACA layers as described in Hatch et al., (Nature Biotech. 19:461-465 (2001); Munson et al., (Analytica Chim. Acta 507:63-71 (2004)

To better characterize the operating parameters required for a successful seal, a second round of optimization experiments use the platen press mentioned above to control the temperature and pressure. The devices made during this study are being evaluated with three function tests: (1) the basic “suitability-for-use” test, including quantitation by the application of a numerical suitability ranking based on well-defined metrics, (2) the yield pressure for the bond, and (3) the dimensional fidelity by measuring the actual dimensions of the channels after SATW.

Results:

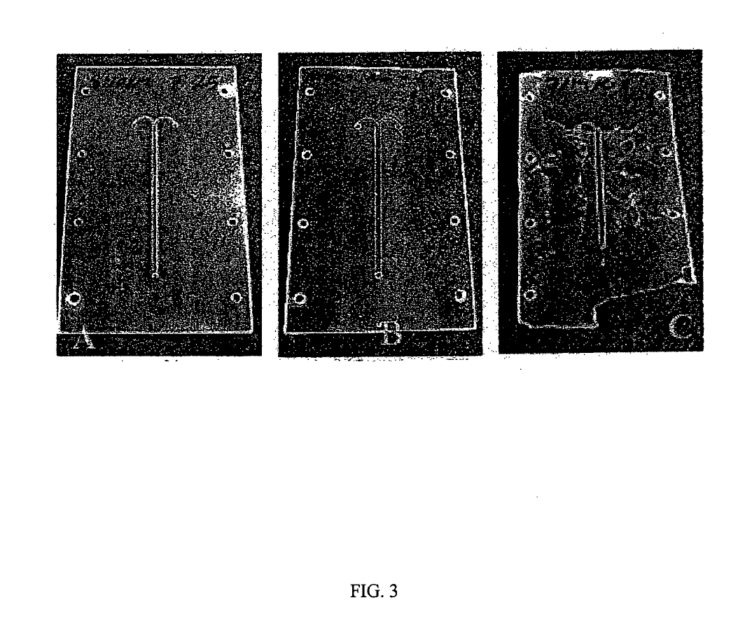

The preliminary work identified the bonding parameters capable of producing devices that sealed against the pressured normally applied to microfluidic chips in our work, (about 5 psi) and that maintained adequate dimensional fidelity. Successful fabrication was determined visually (FIG. 3A) and by the reasonable agreement between experimental results and numerical prediction of those results over a three-dimensional domain identical to the nominal dimensions of the device. (The transport and reaction in both the T-sensor and sheath-flow devices was first simulated with a numerical model that assumed the devices had the nominal design dimensions. If the fabrication process had greatly changed those dimensions, the simulation was not expected to predict the observed behavior. The simulation adequately predicted the observed behavior.)

The preliminary work herein also resulted in the identification of the failure modes that bracketed the useable parameters. (FIGS. 3B and 3C.). The failure of some devices to seal was the result of too little pressure, heat and/or ethanol exposure. Devices with very poor dimensional fidelity (to the point of the channel being completely obliterated) resulted when too much pressure, heat and/or ethanol exposure was applied.

Two other process parameters were also discovered that impacted the quality of the final device: 1) the flatness of the pressing jig, and 2) the surface roughness of the jig.

Jig flatness has been shown to be a factor in the uniformity of the seal obtained. The first generation jig had a slight warp remaining from the manufacturing of the aluminum stock which prevented it from functioning optimally. A second-generation jig was made that has been surface-machined for improved flatness, but even application of pressure to the assembly was still important. Better results were obtained when the jig was sandwiched between two smaller steel plates during application of force. We hypothesize that this mitigated the slight residual warpage of the jig, resulting in more even pressure, and therefore sealing. The results of this technique are seen in FIG. 3A.

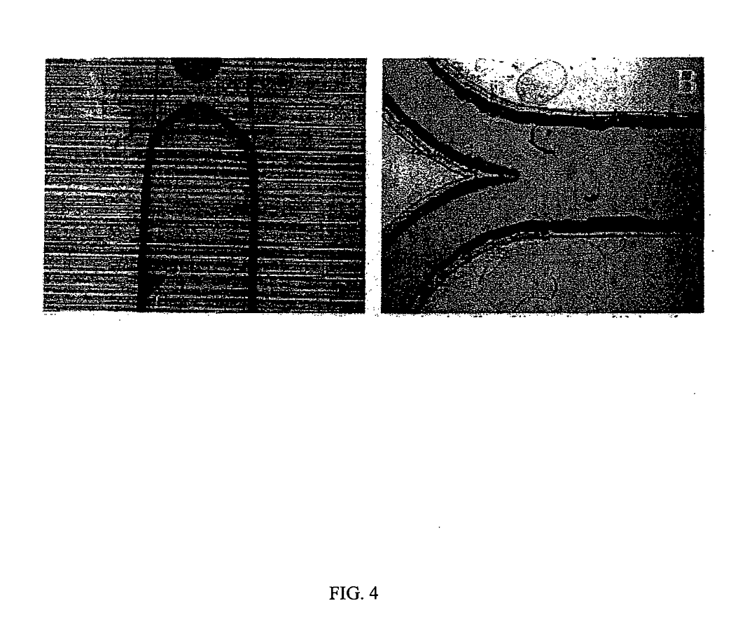

The surface roughness of the jig also impacted the quality of the final device. Since the soaking of the parts in the disrupting fluid creates a reactive layer on all surfaces, the surfaces in contact with the jig also melt, and assume the characteristics of the jig surface. Thus scratches and tooling marks are transferred to the outer surfaces of the device. This was shown to result in cosmetic defects (FIG. 4A), although the presence of surface scratches may not result in functional failures in many applications. In applications where optical interrogation is required, the roughness could be confounding. The roughness was successfully mitigated in two ways; (1) by polishing the jig surface to a mirror finish (first generation jig), and (2) by inserting a smooth Mylar part in between the jig and the device assembly that will not bond to the device. The polishing gave better results (FIG. 4B), but was very time consuming, and may reduce the overall flatness required.

The use of solvent assisted thermal welding (SATW) for bonding bulk polymer films can enable adhesive-free lamination of through-cut films into three-dimensional microfluidic networks the size of a credit card. This represents an improvement over existing processes.

Although the foregoing invention has been described in some detail by way of illustration and example for purposes of clarity of understanding, it will be obvious that certain changes and modifications may be practiced within the scope of the appended claims. The scope of the invention should be determined with reference to the appended claims along with their full scope of equivalents.

All publications and patent documents cited in this application are incorporated by reference in their entirety for all purposes to the same extent as if each individual publication or patent document were so individually denoted.

What is claimed is:

1. A method for fabricating a microfluidic device, the method comprising:
providing a plurality of device layers comprising a bulk chemical conformation composition having a glass transition temperature that can be disrupted by a disrupting agent without total solvation, wherein the plurality of device layers when assembled define a plurality of defined component features;
immersing the plurality of device layers into the disrupting agent for a time period sufficient to disrupt the glass transition temperature of a defined depth of the surfaces of the device layers;
assembling and registering the plurality of device layers by contacting the plurality of device layer surfaces to form the defined component features;
applying simultaneous pressure and heat to bring the plurality of device layers to a temperature below the pressure-specific, glass transition temperature of the bulk chemical conformation composition, but above the pressure-specific, glass transition temperature of the disrupted surface layer of the composition, for a time period sufficient to affect a weld between the contacted surfaces of the plurality of device layers; and
incrementally reducing the temperature over a time period sufficient to anneal the plurality of device layers.

2. The method of claim 1, wherein pressure is applied to the plurality of device layers with a first substantially flat platen and a second substantially flat platen.

3. The method according to claim 2, wherein the heat is applied through the platens.

4. The method of claim 1, wherein assembling and registering the plurality of device layer is carried out with an assembly jig that maintains the proper registration of the plurality of device layers to form the defined component features.

5. The method according to claim 4, wherein the assembly jig and plurality of device layers are placed in an oven.

6. The method of claim 1 comprising
removing the plurality of device layers from the disrupting agent after immersing the plurality of device layers into the disrupting agent; and
removing excess disrupting agent from the plurality of device layers.

7. The method according to claim 1, wherein the plurality of device layers include a first and second cover layer and a plurality of device layers cut through such that when assembled the plurality of device layers form the defined component features.

8. The method according to claim 1, wherein the bulk chemical conformation composition is a polymer film.

9. The method according to claim 8, wherein the polymer film is polymethyl methacrylate (PMMA), a cyclic polyolefin, a polycarbonate, or a polystyrene.

10. The method according to claim 1, wherein the disrupting agent is a solvent.

11. The method according to claim 10, wherein the solvent penetrates into the bulk chemical conformation composition and disrupts the chemical conformation of the polymer sufficiently to lower the glass transition temperature of the composition to form a surface reactive layer without completely dissolving or softening the entire bulk of the composition.

12. The method according to claim 1, wherein the solvent is ethanol, benzaldehyde, an aldehyde, or an acetone of an aldehyde.

13. The method according to claim 9, wherein the polymer film is polymethyl methacrylate and the disrupting fluid is ethanol; the polymer film is a cyclic polyolefin and the disrupting fluid is benzaldehyde; the polymer film is a polycarbonate and the disrupting fluid is acetone; or the polymer film is polystyrene and the disrupting fluid is an aldehyde.

14. A method for fabricating a microfluidic device with the steps comprising:
providing a first substantially flat platen and a second substantially flat platen;
providing a plurality of device layers comprising polymethyl methacrylate, wherein the plurality of device layers when assembled define a plurality of defined component features;
providing an assembly jig that maintains the proper registration of the plurality of device layers to form the defined component features;
immersing the plurality of device layers into ethanol for a time period sufficient to disrupt the glass transition temperature of a defined depth of the surfaces of the device layers;
removing the plurality of device layers from the ethanol;
removing excess ethanol from the plurality of device layers;
assembling the plurality of device layers onto the assembly jig by contacting the plurality of device layer surfaces to form the defined component features;
applying simultaneous pressure and heat to the first and second platen, wherein heat is applied to bring the assembly to a temperature below the pressure-specific, glass transition temperature of the polymethyl methacrylate; but above the pressure-specific, glass transition temperature of the disrupted surface layer of the polymethyl methacrylate, for a time period sufficient to affect a weld between the contacted surfaces of the plurality of device layers; and
reducing incrementally the temperature of the first and second platen, and the assembly jig over a time period sufficient to anneal the contacted surfaces of the plurality of device layers to form the microfluidic device.

15. The method according to claim 14, wherein the device layers are 0.175 mm thick, time period is ten minutes, and the assembly is heated to 95° C for 90 minutes.

16. The method according to claim 14, wherein the ethanol is absolute ethanol.

17. The method according to claim 14, wherein the device assembly is heated in an oven.

18. The method according to claim 14, wherein the platen is substantially flat and smooth.

19. The method according to claim 14, wherein the surface of the platen is covered with a material layer that is substantially smooth.

20. The method according to claim 19, wherein the material layer is Mylar.

21. The method according to claim 20, wherein the outer layers comprise a first and second cover layer.

22. The method according to claim 21, wherein the first and second cover layer comprise Mylar.

23. A microfluidic device having a plurality of component features, wherein the device comprises a plurality of device layers fabricated by the method of claim 1.

24. The microfluidic device according to claim 23, wherein the wherein the device comprises a first and second cover layer and a device layer having a plurality of component features.

25. The microfluidic device according to claim 23, wherein the device comprises a plurality of core layers fabricated by the methods of claim 1 and a plurality of outer layers fabricated using an adhesive.

26. An adhesiveless microfluidic device comprising a plurality of device layers of a bulk chemical conformation composition including, a first and second cover layer, and at least one device layer cut through defining one or more component features, wherein the device layers are welded together by a weld that is chemically and mechanically indistinguishable from the bulk composition.

27. The device according to claim 26, wherein the bulk chemical conformation composition is a polymer or a co-polymer.

28. The microfluidic device according to claim 27, wherein the polymer or co-polymer is a thermoplastic.

29. The device according to claim 27, wherein the polymer or co-polymer comprises an acrylate, a polyolefin, a polycarbonate, or a polystyrene.

30. The device according to claim 29, wherein the acrylate is polymethyl methacrylate.

31. The device according to claim 26, wherein the bulk chemical conformation composition has been contacted with a disrupting fluid prior to fabrication.

32. The device according to claim 31, wherein the disrupting fluid can depress the T_{g} of the surface layers of the bulk chemical conformation composition sufficiently to enable the surface layers to be brought above the T_{g} without the bulk temperature exceeding the bulk T_{g}.
